(19) United States
(12) Patent Application Publication
(10) Pub. No.: US 2020/0057943 A1
(43) Pub. Date: Feb. 20, 2020

(54) METHOD AND SYSTEM FOR LOW-POWER VISUAL SENSOR

(71) Applicant: ANTS TECHNOLOGY (HK) LIMITED, HONG KONG (HK)

(72) Inventors: Ron FRIDENTAL, Shoham, IL (US); Eli SUDAI, Pardsiya, IL (US)

(21) Appl. No.: 16/102,838

(22) Filed: Aug. 14, 2018

(51) Int. Cl. G06N 5/00; G06T 11/00; G06F 17/30

(52) U.S. Cl. CPC G06N 5/00; G06F 17/30047; G06T 11/005

(57) ABSTRACT

A raw-data analysis system and method, the system including an image sensor configured to capture and transmit raw image data, a decision module configured to receive from the image sensor raw image data unprocessed by an image signal processor, and decide whether the raw image data implies an activity of interest, and at least one controller configured to control what subset of the raw image data the image sensor transmits to the decision module. Additionally, an image data analysis system including a photo-detector, a sensor module configured to detect a state of interest, an image sensor configured to capture and transmit raw image data, and a controller configured to receive an illumination level value from the photo-detector and to control the image sensor to operate with settings that match the received illumination level value once the sensor module detects a state of interest.

### BACKGROUND

Some known sensing systems, such as motion sensors or smoke detectors, use visual data to enhance the efficiency and accuracy of the system and reduce false alarms, for example by better understanding the situation. In an exemplary case, once a motion sensor detects motion in a monitored area, it may trigger an image sensor that may capture images of the monitored area. Based on the images, the system shay decide whether an action should be taken, such as setting off an alarm.

For example, some systems use an artificial intelligence decision module, such as a neural network and/or machine learning component, to decide if sensor data such as image data captured by the camera imply occurrence of an activity of interest, for example an activity with specific properties or an unusual or suspicious activity. If an activity of interest is detected, i.e. the decision module decides that suspicious activity is implied by the sensor data, an alarm is triggered. This method reduces costs caused by false alarms.

For example, known security devices use Infrared (IR) sensors, usually passive IR sensors that measures IR light radiating from objects in their field of view. Some devices include a camera that enables identification of a suspect body, for example by a security person inspecting the captured images, for example after the device triggers an alarm, when the IR sensor senses unusual activity. Some devices, to reduce energy consumption, operate the camera only after the alarm is triggered.

Reference is now made to FIG. 1, which is a schematic illustration of a prior-art security device 900. Device 900 includes an image sensor 90, a buffer memory 92, an Image Signal Processor (ISP) 94 and an artificial intelligence (AI) decision module 96. AI decision module 96 may include an image processing neural network hardware and/or software component, and/or may classify, compress and/or perform any other suitable decision or modification based on input data. Usually, image sensor 90 transmits raw image data to buffer memory 92. Memory 92 stores the raw data and functions as a buffer to enable ISP 94 to use and/or process new raw image sensor data once free from previous tasks. Image sensor 90 may include, for example, a Charge-Coupled Device (CCD), a Complementary Metal-Oxide Semiconductor (CMOS), and/or any other suitable semiconductor image sensing device.

Raw image data is unprocessed or minimally processed data captured by the image sensor. The raw data is not ready to be printed, displayed or edited by a bitmap graphics editor and is not directly usable as an image, but has all the information needed to create an image. Raw image data may have a wider dynamic range or color gamut than the eventual final image format. The raw data is sensed according to the geometry of the sensor's individual photo-receptive elements rather than points in the expected final image. For example, sensors with hexagonal element displacement record information for each of their hexagonally-displaced cells. Similarly, sensors with other element structure may generate other, respective, forms of raw data. The raw data may include partial pixel color data information in each element, rather than having all the RGB information for each point in the expected final image. The raw data is sensed according to color filters attached to the sensors individual photo-receptive elements. Such incomplete pixel data can be of one of R, G, B, or IR or one of the complementary components such as magenta, cyan, yellow, or other color space components, depending on the color filter format.

ISP 94 may include a processing device and/or software, and/or may process the raw data to convert it to an image data format, usually with rectangular geometry, adaptable for displaying, printing, and/or otherwise presenting the image data, for example to a human user in accordance to human perception of color, such as Red-Green-Blue (RGB) image data, Cyan-Magenta-Yellow-Key (CMYK) image data, or any other suitable image data format. Accordingly, in prior art devices, ISP 94 receives raw image data from sensor 90 and/or memory 92 and converts the raw data to image pixels usable as an image and/or ready to be printed, displayed and/or edited by a bitmap graphics editor. The converted image data may then be transmitted to AI decision module 96.

AI module 96 receives the converted image data as input and analyzes the converted image data to decide if the converted image data received from memory 92 and/or ISP 94 imply an activity of interest. In case decision module 96 decides that suspicious activity is implied by the image data, i.e. a suspicious activity is detected by AI module 96, an alarm is triggered, and/or any other suitable output is transmitted, for example to a security server.

### SUMMARY

An aspect of some embodiments of the present disclosure provides a raw-data analysis system including an image sensor configured to capture and transmit raw image data, an AI decision module configured to receive from the image sensor raw image data, unprocessed by an image signal processor, and decide Whether the raw image data implies suspicious activity, and at least one controller configured to run code instructions and to control the image sensor according to the code instructions to transmit at least a subset of the raw image data.

Optionally, the controller is configured to receive from the AI decision module information generated during a decision process of the decision module and to control the image sensor according to the received information.

Optionally, the controller is configured to instruct the image sensor, according to the received information, to zoom in to a region of interest and to capture a higher-resolution raw image data of the region of interest, and to transmit at least a subset of the higher-resolution raw image data to the decision module.

Optionally, the AI decision module comprises a delay line component that stores a number of lines of raw image data required for processing of a minimal pixel area of the raw image data by a layer of the decision module.

Optionally, the controller is configured to transmit a notice in case suspicious activity is detected by the decision module.

Optionally, the notice comprises or is transmitted along with a corresponding at least one subset of raw data.

Optionally, the corresponding at least one subset of raw data comprises raw data of a next frame captured after the raw data processed by the decision module is captured.

Optionally, the notice comprises or transmitted along with a feature vector representing the corresponding at least one subset of raw data, enabling reconstruction of an image based on the feature vector.

Optionally, the controller is configured to transmit the corresponding at least a subset of raw data or a feature vector representing the corresponding at least one subset of raw data continuously or periodically, enabling a receiving server to produce an image from the corresponding raw data and/or feature vector.

Optionally, the system including a low-resolution image sensor and a high-resolution image sensor, and wherein the controller is configured to instruct the low-resolution image sensor to transmit raw image data to the decision module, and to instinct the high-resolution image sensor based on information received from the decision module.

Optionally, the AI decision module comprises a permanent ad-hoc artificial neural network, pre-configured to perform a specific kind of decision, for a specific application.

Optionally, the AI decision module is configured with pre-determined weights of the neural network nodes written inside a non-volatile memory.

Optionally, the AI decision module comprises hard-wired weights of the neural network nodes or weights implemented in a replaceable metal layer.

Another aspect of some embodiments of the present disclosure provides a raw-data analysis method including capturing a frame of raw image data by an image sensor, controlling the image sensor to transmit at least a subset of the raw image data, and receiving from the image sensor, by an AI decision module, raw image data unprocessed by au image signal processor, and deciding whether the raw image data implies suspicious activity.

Optionally, the method including receiving from the AI decision module information generated during a decision process of the decision module and controlling the image sensor according to the received information.

Optionally, the method including instructing the image sensor, according to the received information, to zoom in to a region of interest and to capture a higher-resolution raw image data of the region of interest, and to transmit at least a subset of the higher-resolution raw image data to the decision module.

Optionally, the method including storing in a delay line component a number of lines of raw image data required for processing of a minimal pixel area of the raw image data by a layer of the decision module.

Optionally, the method including transmitting a corresponding at least one subset of raw data in case a suspicious activity is detected by the decision module.

Optionally, the corresponding at least one subset of raw data comprises raw data of a next frame captured after the raw data processed by decision module is captured.

Optionally, the method including transmitting a feature vector representing the responding at least a subset of raw data, enabling reconstruction of an image based on the feature vector, in case a suspicious activity is detected by the decision module.

Another aspect of some embodiments of the present disclosure provides an image data analysis system including a photo-detector, a sensor module configured to detect a state of interest, an image sensor configured to capture and transmit raw image data, and a controller configured to receive an illumination level value from the photo-detector and to control the image sensor to operate with settings that match the received illumination level value upon activation of the image sensor, once the sensor module detects a state of interest.

### BRIEF DESCRIPTION OF THE DRAWINGS

Some on-limiting exemplary embodiments or features of the disclosed subject matter are illustrated in the following drawings.

In the drawings:

FIG. 1 is a is a schematic illustration of a prior-art security device;

FIG. 2 is a schematic illustration of a raw-data analysis system, according to some embodiments of the present disclosure;

FIG. 3 is a schematic illustration of operation of a delay-line component of a decision module, according to some embodiments of the present disclosure; and

FIG. 4 is a schematic flowchart illustrating a method for raw-data analysis, according to some embodiments of the present disclosure.

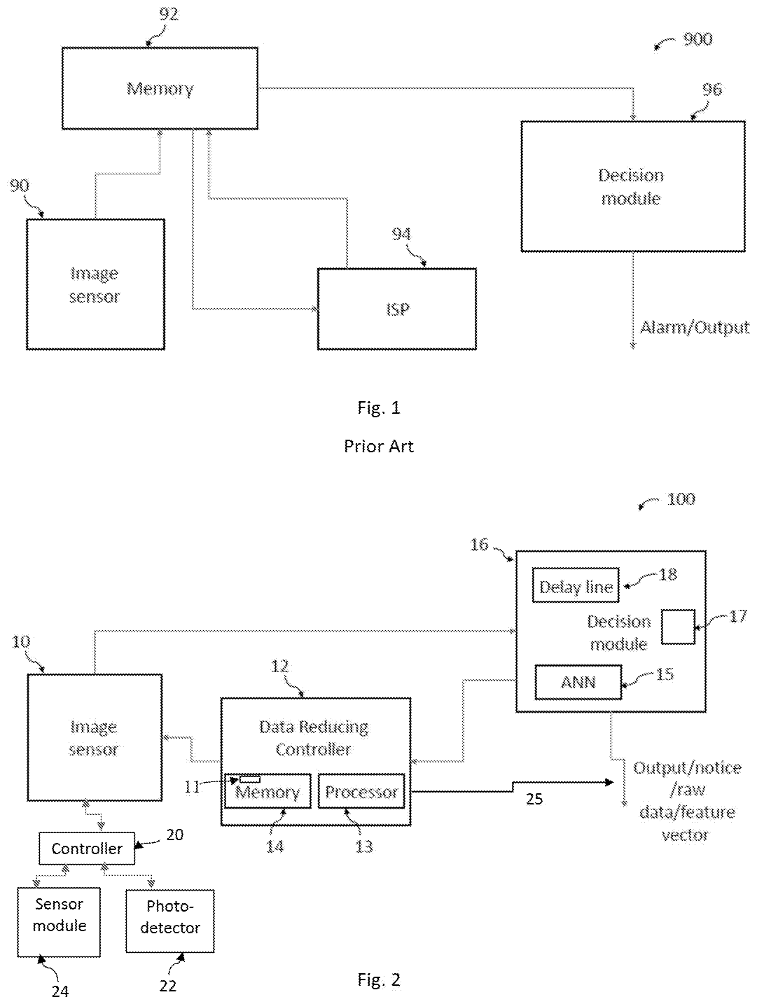

With specific reference now to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

Identical or duplicate or equivalent or similar structures, elements, or parts that appear in one or more drawings are generally labeled with the same reference numeral, optionally with an additional letter or letters to distinguish between similar entities or variants of entities, and may not be repeatedly labeled and/or described. References to previously presented elements are implied without necessarily further citing the drawing or description in which they appear.

Dimensions of components and features shown in the figures are chosen for convenience or clarity of presentation and are not necessarily shown to scale or true perspective. For convenience or clarity, some elements or structures are not shown or shown only partially an or with different perspective or from different point of views.

### DETAILED DESCRIPTION

An exemplary embodiment of the present disclosure provides a system and method for low-power and low-maintenance-cost data analysis, According to some embodiments of the present disclosure, memory capacity and processing power is saved by an economic data analysis device and method with an altered structure and sequence of data flow.

As described in detail herein above, processing of raw image data to generate an image (for example, an RGB image) before deciding based on the image data consumes a lot of time, space and power, and requires the device to include a memory (92) that consumes space and power. Some embodiments of the present invention solve this problem by enabling the removal of image processing from the decision flow.

Additionally, known image sensors cannot capture an image immediately upon triggering of the image sensor because the first frames are used for adjusting the sensor to the illumination level. However, for devices that require a quick response and decisions based on current occurrences, waiting for the image sensor to adjust may fail the purpose of the device. Additionally, the adjustments consume battery power. Some embodiments of the present disclosure solve this problem by enabling detection of the illumination level before triggering of the image sensor and controlling the image sensor to operate with settings that match the received illumination level value immediately upon activation of the image sensor, thus refraining from delays in capturing a current image and enabling an improved and economic operation, and saving battery power.

Before explaining at least one embodiment of the disclosure in detail, it is to be understood that the disclosure is not necessarily limited in its application to the details of construction and the arrangement of the components and/or methods set forth in the following description and/or illustrated in the drawings and/or the examples. The disclosure is capable of other embodiments or of being practiced or carried out in various ways.

Reference is now made to FIG. 2, which is a schematic illustration of a raw-data analysis system 100, according to some embodiments of the present disclosure. Analysis system 100 includes an image sensor 10, a data reduction controller 12 and AI module 16. Data reduction controller 12 may include at least one hardware processor 13 and a hardware non-volatile memory 14, for example including a read-only memory (ROM) and/or any other kind of hardware memory. Optionally, controller 12 may include a software component (e.g. 11 in memory 14). In some embodiments, data reducing controller 12 also controls and/or operates AI decision module 16, for example by processor 13 and/or memory 14. Additionally, or alternatively, AI decision module 16 may include at least one hardware processor (not shown) and/or hardware non-volatile memory 17 to control and/or facilitate its operations. AI decision module 16 may include an image processing neural network hardware component, a software component and/or a machine learning component. The components may classify, compress and/or perform any other suitable decision or modification based on input data. Image sensor 10 may include, for example, a CCD, a CMOS, and/or any other suitable semiconductor image sensing device.

In some embodiments of the disclosure, system 100 may also include a photo detector 22, for example a photo-resistor, which may detect the illumination level for setting sensor 10 to a current illumination level upon activation of sensor 10. Photo detector 22 may transmit to a controller 20 of image sensor 10 a current illumination level value in the environment of system 100. Therefore, upon triggering of image sensor 10, controller 20 may configure the settings of image sensor 10 to match the current illumination level and then control image sensor 10 to start capturing images with settings that correspond to the current illumination level detected by photo detector 22, upon activation of the image sensor.

According to some embodiments, system 100 may include a sensor module 24 that may include sensors to detect various states in the environment of system 100, such as motion sensors or smoke detectors. Sensor module 24 may be configured to identify a certain state of states of interest, for example to detect a certain amount of smoke or motion. Once sensor module 24 detects a state of interest, it may send a signal to controller 20, which may then receive an illumination level value from photo-detector 22 and control image sensor 10 to operate with settings that match the received illumination level value, for example immediately upon activation of the image sensor.

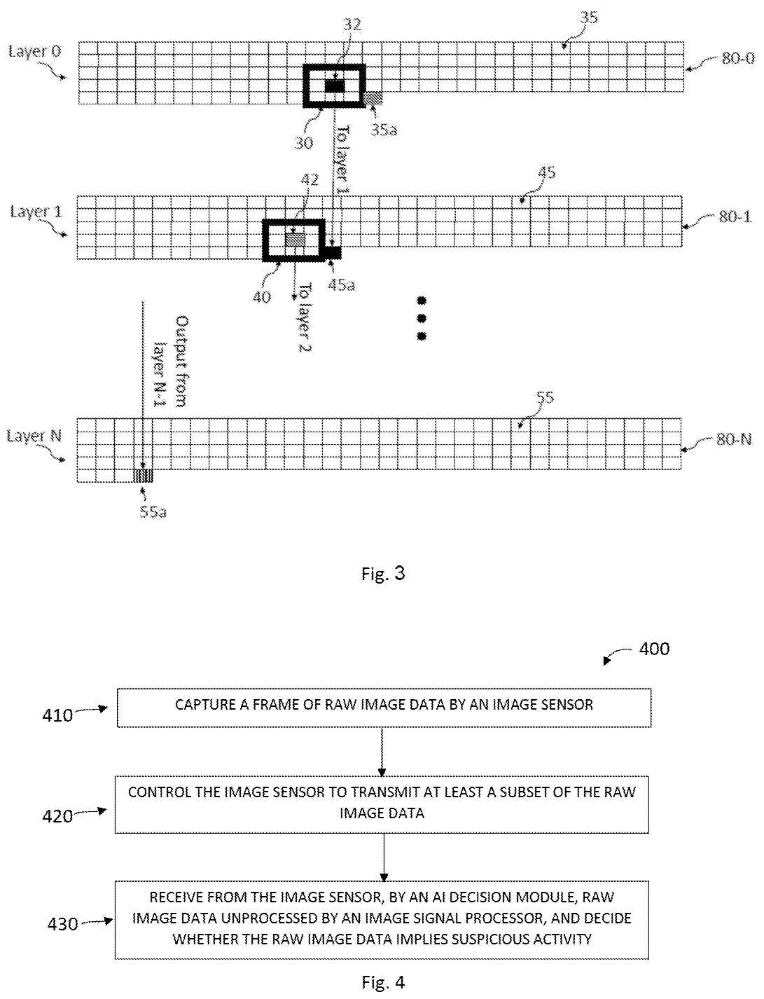

Image sensor 10 may have a field of view, of which image sensor 10 may capture a frame of raw image data and transmit at least a portion of the raw data to decision module 16, optionally by a delay line component 18, as described in more detail herein with reference to FIG. 3. Usually, the size of the captured raw data, of each captured frame, is much bigger than the size of data processible by decision module 16 in a decision operation. For example, in some configurations, raw image data of a certain frame captured by image sensor 10 may be about hundred times larger than the data size processible by decision module 16. According to some embodiments of the present disclosure, image sensor 10 receives instructions from data reduction controller 12 that instruct sensor 10 what portion of the raw image data should be transmitted to decision module 16. For example, processor 13 may instruct sensor 10 to transmit a certain subset of the raw data lines. For example, processor 13 may instruct sensor 10 to transmit one line of data out of every 10, 50, or 100 lines of the captured raw data or any other suitable portion. In other embodiments, processor 13 may instruct sensor 10 to transmit raw image data of a certain region of interest in the captured raw image data. In some embodiments, processor 13 may instruct sensor 10 to adapt the subset of the raw data to a data size processible by decision module 16.

Decision module 16 may receive the raw data subset for sensor 10 and may perform a decision process, for example by a suitable artificial neural network 15. In some embodiment, decision module 16 may be configured to detect suspicious activity, i.e. to decide if the received data subset includes and/or implies suspicious activity. In some embodiments of the present disclosure, in case suspicious activity is detected, decision module 16 and/or data reduction controller 12 transmits a notice 25, for example to a security server or any other local or remote server. In some embodiments, the notice 25 includes or is sent along with corresponding raw data, a raw data subset, or any other suitable data that may enable a rendering system (not shown) to generate an image data representation showing the detected suspicious activity, for example to a security person. In some embodiments, the corresponding raw data includes raw data of a next frame captured after the raw data processed by decision module 16 is captured, which usually includes a substantial portion of the information included in the processed frame. Thus, for example, there is no need to store the processed frame.

In an exemplary embodiment of the disclosure, decision module 16 and/or data reduction controller 12 may generate and/or transmit as output, for example when suspicious activity is detected, a feature vector representing the corresponding raw data and/or the corresponding data subset that may enable reconstruction of an image based on the feature vector. In some embodiments, decision module and/or data reduction controller 12 may transmit as output the raw data and/or the data subset and/or a generated feature vector continuously or periodically during the decision process, for example together with corresponding time stamps. Optionally, once the notice 25 is sent, a server that receives the output raw data and/or feature vector may produce an image from the corresponding raw data and/or feature vector. In some embodiments, data reduction controller 12 may generate and/or transmit as output a thumbnail representing the corresponding raw image data or data subset.

In some embodiments of the disclosure, decision module 16 may include a plurality of layers or portions, each performing another task and/or processing another aspect of the received raw data. For example, one network portion may recognize motion, and/or another network portion may identify a type of a moving object, for example decide if the moving object is a wind-bell or a cat, and/or may make any other suitable decision. Processor 13 may receive from various layers corresponding kinds of information, i.e. the results and/or temporary results of the task and/or processing performed in the various portions. In some embodiments, information received from a certain portion of decision module 16 may enable processor 13 to generate and provide instructions to image sensor 10 according to the received information. For example, processor 13 may receive from decision module 16 information about a region of interest in the field of view. Based on the information, processor 13 may instruct image sensor 10 to zoom in to the region of interest, and thus, for example, image sensor 10 may capture a higher-resolution raw image data of the region of interest. At least a subset of this higher-resolution raw data may be transmitted to decision module 16 for processing and decision making.

Reference is now made to FIG. 3, which is a schematic illustration of operation of delay-line component 18 of decision module 16, according to some embodiments of the present disclosure. It will be appreciated that in FIG. 3 the data is presented in two dimensions for simplicity, even though the data may have a higher dimensionality, and the disclosure is not limited in that respect. Delay line 18 may be a software and/or hardware component configured to store a few lines of raw image data in a random-access memory (RAM). In an exemplary embodiment of the disclosure, artificial neural network 15 may include N layers. Each layer may require a certain minimal area of raw data pixels around a certain raw data pixel for processing the certain raw data pixel and/or area. Each layer Layer 0, Layer 1, . . . Layer N may have a corresponding cyclic buffer 80-0, 80-1, . . . 80-N storing a determined number of rows of pixels previously received from image sensor 10, by delay line component 18. For example, FIG. 3 shows that layer 0 processes a 3×3 minimal pixel area 30 around a received pixel 32 of the captured frame of raw image data. In some embodiments of the present disclosure, raw data captured by image sensor 10 may be transmitted pixel by pixel to decision module 16. For example, once a pixel 35a is captured by image sensor 10, it is transmitted to decision module 16. In some embodiments, when a single pixel is not sufficient for processing by a layer of network 15, it is stored by delay-line component 18 in a cyclic buffer of this layer. For example, in case a n×n minimal pixel area is required for processing image data by a specific layer of network 15, at least n-1 rows of image data are stored in delay line 18, in a cyclic buffer corresponding to the specific layer. For example, cyclic buffer 80-0 stores pixels 35 previously received from sensor 10, and cyclic buffer 80-1 stores pixels 45 previously received from Layer 0. Once sufficient raw data pixels are received by decision module 16, Layer 0 (the first layer) of network 15 can process a pixel 32 with minimal pixel area 30 and transmit the result to Laver 1 (the second layer), in which the result may be represented as a pixel 45a of Layer 1. Accordingly, during operation, each time a new minimal pixel area is obtained by decision module 16, for example in a layer of network 15 in combination with delay-line 18, this layer processes the required pixel area and transmits the result to a next layer. For example, a Layer N receives a pixel 55a from Layer N-1, after a respective pixel and/or pixel area is processed in Layer N-1. Accordingly, cyclic buffer 80-N stores pixels 55 previously received from layer N-1.

In some embodiments of the present disclosure, system 100 may include more than one image sensors. For example, system 100 may include a low-resolution image sensor for an early stage, by which low-resolution raw data is captured and transmitted to module 16 to perform an early-stage analysis, for example recognition of a region of interest. Based on the early stage analysis, processor 13 may instruct an image sensor to capture higher-resolution image data of a specific region.

In some embodiments, data reduction controller 12 and/or decision module 16, for example by processor 13, may be configured to instruct sensor 10 to transmit raw image data of another captured frame once a decision and/or certain information is generated by and/or received from decision module 16.

In some embodiments, AI decision module 16 may include and/or run more than one artificial neural network 15, and/or the cyclic buffer memory mechanism may serve the more than one network 15. For example, one network may be used for detection and another one may be used for tracking. For example, one network 15 may analyze data after the other network 15 analyzes data, or the networks may analyze data at least partially concurrently.

According to some embodiments of the present disclosure, neural network 15 of AI decision module 16 may be a permanent ad-hoc artificial neural network, pre-configured to perform a specific kind of decision, for example for a specific application. In an exemplary embodiment of the disclosure, AI decision module 16 may be configured with pre-determined weights of the neural network nodes, for example constant preconfigured weights. In some embodiments, at least some of the weights and/or other parameters of AI decision module 16 are written inside a non-volatile memory 17. Alternatively or additionally, at least some of the weights and/or other parameters of decision module 16 may be hard-wired, e.g. permanently implemented in a printed circuit and/or other hardware components of decision module 16. Alternatively or additionally, at least some of the weights and/or parameters are implemented in a metal layer of decision module 16, which may be cheap and easily replaceable, for example to customize decision module 16 for a specific application. Alternatively or additionally, at least some of the weights and/or parameters are implemented by fusing into the circuits of module 16 in the manufacturing process, of decision module 16.

Reference is now made to FIG. 4, which is a schematic flowchart illustrating a method 400 for raw-data analysis, according to some embodiments of the present disclosure. As indicated in block 410, image sensor 10 may capture a frame of raw image data, as described in more detail herein above. As indicated in block 420, processor 13 may control the image sensor to transmit at least a subset of the raw image data, as described in more detail herein above. As indicated in block 430, AI decision module 16 may receive from the image sensor raw image data unprocessed by an image signal processor and may decide whether the raw image data implies suspicious activity, as described in more detail herein above. Optionally, processor 13 may receive from the AI decision module 16 information generated during a decision process of the decision module and control the image sensor 10 according to the received information. Optionally, processor 13 may instruct the image sensor 10, according to the received information, to zoom in to a region of interest and to capture a higher-resolution raw image data of the region of interest, and to transmit at least a subset of the higher-resolution raw image data to the decision module 16. Optionally, decision module 16 may store in a delay line component 18 a number of lines of raw image data required for processing of a minimal pixel area of the raw image data by a layer of the decision module. Optionally, processor 13 may transmit a corresponding at least one subset of raw data in case suspicious activity is detected by the decision module 16. Optionally, the corresponding at least one subset of raw data comprises raw data of a next frame captured after the raw data processed by decision module 16 is captured. Optionally, processor 13 may transmit a feature vector representing the corresponding at least a subset of raw data, enabling reconstruction of an image based on the feature vector, in case a suspicious activity is detected by the decision module.

Some embodiments of the present disclosure may include a system, a method, and/or a computer program product. The computer program product may include a tangible non-transitory computer readable storage medium (or media) having computer readable program instructions thereon for causing a processor to carry out aspects of the present disclosure. Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including any object oriented programming language and/or conventional procedural programming languages.

In the context of some embodiments of the present disclosure, by way of example and without limiting, terms such as ‘operating’ or ‘executing’ imply also capabilities, such as ‘operable’ or ‘executable’, respectively.

Conjugated terms such as, by way of example, ‘a thing property’ implies a property of the thing, unless otherwise clearly evident from the context thereof.

The terms ‘processor’ or ‘computer’, or system thereof, are used herein as ordinary context of the art, such as a general purpose processor, or a portable device such as a smart phone or a tablet computer, or a micro-processor, or a RISC processor, or a DSP, possibly comprising additional elements such as memory or communication ports. Optionally or additionally, the terms ‘processor’ ‘computer’ or derivatives thereof denote an apparatus that is capable of carrying out a provided or an incorporated program and/or is capable of controlling and/or accessing data storage apparatus and/or other apparatus such as input and output ports. The terms ‘processor’ or ‘computer’ denote also a plurality of processors or computers connected, and/or linked and/or otherwise communicating, possibly sharing one or more other resources such as a memory.

The terms ‘software’, ‘program’, ‘software procedure’ or ‘procedure’ or ‘software code’ or ‘code’ or ‘application’ may be used interchangeably according to the context thereof, and denote one or more instructions or directives or electronic circuitry for performing a sequence of operations that generally represent an algorithm and/or other process or method. The program is stored in or on a medium such as RAM, ROM, or disk, or embedded in a circuitry accessible and executable by an apparatus such as a processor or other circuitry. The processor and program may constitute the same apparatus, at least partially, such as an array of electronic gates, such as FPGA or ASIC, designed to perform a programmed sequence of operations, optionally comprising or linked with a processor or other circuitry.

The term ‘configuring’ and/or ‘adapting’ for an objective, or a variation thereof, implies using at least a software and/or electronic circuit and/or auxiliary apparatus designed and/or implemented and/or operable or operative to achieve the objective.

A device storing and/or comprising a program and/or data constitutes an article of manufacture. Unless otherwise specified, the program and/or data are stored in or on a non-transitory medium.

In case electrical or electronic equipment is disclosed it is assumed that an appropriate power supply is used for the operation thereof.

The flowchart and block diagrams illustrate architecture, functionality or an operation of possible implementations of systems, methods and computer program products according to various embodiments of the present disclosed subject matter. In this regard, each block in the flowchart or block diagrams may represent a module, segment, or portion of program code, which comprises one or more executable instructions for implementing the specified logical function(s). It should also be noted that, in some alternative implementations, illustrated or described operations may occur in a different order or in combination or as concurrent operations instead of sequential operations to achieve the same or equivalent effect.

The corresponding structures, materials, acts, and equivalents of all means or step plus function elements in the claims below are intended to include any structure, material, or act for performing the function in combination with other claimed elements as specifically claimed. As used herein, the singular forms “a”, “an” and “the” are intended to include the plural forms as well, unless the context clearly indicates otherwise. It will be further understood that the terms “comprising”, “including” and/or “haying” and other conjugations of these terms, when used in this specification, specify the presence of stated features, integers, steps, operations, elements, and/or components, but do not preclude the presence or addition of one or more other features, integers, steps, operations, elements, components, and/or groups thereof.

The terminology used herein should not be understood as limiting, unless otherwise specified, and is for the purpose of describing particular embodiments only and is not intended to be limiting of the disclosed subject matter. While certain embodiments of the disclosed subject matter have been illustrated and described, it will be clear that the disclosure is not limited to the embodiments described herein. Numerous modifications, changes, variations, substitutions and equivalents are not precluded.

1. A raw-data analysis system comprising:
an image sensor configured to capture and transmit raw image data;
a decision module configured to receive from the image sensor raw image data unprocessed by an image signal processor, and decide whether the raw image data implies an activity of interest; and
at least one controller configured to control what subset of the raw image data the image sensor transmits to the decision module.

2. The system of claim 1, wherein the at least one controller is configured to run code instructions and to control the image sensor according to the code instructions to transmit a subset of the raw image data.

3. The system of claim 1, wherein the controller is configured to receive from the decision module information generated during a decision process of the decision module and to control the image sensor according to the received information.

4. The system of claim 3, wherein the controller is configured instruct the image sensor, according to the received information, to zoom in to a region of interest and to capture a higher-resolution raw image data of the region of interest, and to transmit at least a subset of the higher-resolution raw image data to the decision module.

5. The system of claim 1, wherein the decision module comprises a delay line component that stores a number of lines of raw image data required for processing of a minimal pixel. area of the raw image data by a layer of the decision module.

6. The system of claim 1, wherein the controller is configured to transmit a notice in case suspicious activity is detected by the decision module, wherein the notice comprises or is transmitted along with a corresponding at least one subset of raw data.

7. The system of claim 6, Wherein the corresponding, at least one subset of raw data comprises raw data of a next frame captured after the raw data processed by decision module is captured.

8. The system, of claim 5, wherein the notice comprises or transmitted along with a feature vector representing the corresponding at least one subset of raw data, enabling reconstruction of an image based on the feature vector.

9. The system of claim 5, wherein the controller is configured to transmit the corresponding at least one subset of raw data or a feature vector representing the corresponding at least one subset of raw data continuously or periodically, enabling a receiving server to produce an image from the corresponding raw data and/or feature vector.

10. The system of claim 2, comprising a low-resolution image sensor and a high-resolution image sensor, and wherein the controller is configured to instruct the low-resolution image sensor to transmit raw image data to the decision module, and to instruct the high-resolution image sensor based on information received from the decision module.

11. The system of claim 1, wherein the decision module comprises a permanent ad-hoc artificial neural network, pre-configured to perform a specific kind of decision, for a specific application.

12. The system of claim 11, wherein the decision module is configured with pre-determined weights of the neural network nodes written inside a non-volatile memory.

13. The system of claim 11, wherein the decision module comprises hard-wired weights of the neural network nodes or weights implemented in a replaceable metal layer.

14. A raw-data analysis method comprising:
capturing a frame of raw image data by an image sensor;
controlling the image sensor to transmit a subset of the raw image data; and
receiving from the image sensor, by a decision module, raw image data unprocessed by an image signal processor, and deciding whether the raw image data implies suspicious activity.

15. The method of claim 14, comprising receiving from the decision module information generated during a decision process of the decision module and controlling the image sensor according to the received information.

16. The method of claim 15, comprising instructing the image sensor, according to the received information, to zoom in to a region of interest and to capture a higher-resolution raw image data of the region of interest, and to transmit at least a subset of the higher-resolution raw image data to the decision module.

17. The method of claim 14, comprising storing in a delay line component a number of lines of raw image data required for processing of a minimal pixel area of the raw image data by a layer of the decision module.

18. The method of claim 14, comprising transmitting a corresponding at least one subset of raw data in case suspicious activity is detected by the decision module.

19. The method of claim 18, wherein the corresponding at least one subset of raw data comprises raw data of a next flame captured after the raw data processed by decision module is captured.

20. The method of claim 14, comprising transmitting a feature vector representing the corresponding at least one subset of raw data, enabling reconstruction of an image based on the feature vector, in case suspicious activity is detected by the decision module.

21. A image data analysis system comprising:
a photo-detector;
a sensor module configured to detect a state of interest;
an image sensor configured to capture and transmit raw image data; and
a controller configured to receive an illumination level value from the photo-detector and to control the image sensor to operate with settings that match the received illumination level value once the sensor module detects a state of interest.
